(19) United States
(12) Patent Application Publication
(10) Pub. No.: US 2025/0207972 A1
(43) Pub. Date: Jun. 26, 2025

(54) Method for Monitoring a Functional State of at Least One Household Appliance and Monitoring System

(71) Applicant: Vorwerk & Co. Interholding GmbH, Wuppertal (DE)

(72) Inventors: Benjamin FLECZOK, Essen (DE); Amin NEZAMI, Wuppertal (DE)

(21) Appl. No.: 18/988,040

(22) Filed: Dec. 19, 2024

(30) Foreign Application Priority Data
Dec. 22, 2023 (EP) 23 219 806.9

(51) Int. Cl. G01H 3/08; G01M 99/00; G01S 5/26

(52) U.S. Cl. CPC G01H 3/08; G01M 99/005; G01S 5/26

(57) ABSTRACT

The invention relates to a method (100) for monitoring a functional state of at least one household appliance (11) in a household environment (12) by a monitoring system (10) comprising at least one monitoring device (13), the method (100) comprising:
receiving (110) an acoustic signal (S) from the household environment (12) in the monitoring device (13),
evaluation (120) of the acoustic signal (S) and provision of an evaluation data set (500),
identifying (130) a household appliance (11) in the household environment (12) as the source of the acoustic signal (S) in dependence on the evaluation data set (500) and providing an appliance data set (600),
defining (140) a functional state of the household appliance (11) as a function of the evaluation data set (500) and the appliance data set (600).

The invention relates to a method with the features of independent patent claim 1, a monitoring system with the features of independent patent claim 13, a computer program product with the features of independent patent claim 15, as well as a computer-readable storage medium and a data carrier signal.

In the context of a household environment, various household appliances are regularly operated to support or automatically perform household tasks. For example, cleaning robots, especially vacuum cleaner robots, or classic vacuum cleaners are used to clean floors, food processors and ovens are used to prepare food, washing machines and tumble dryers are used to clean laundry and dishwashers are used to clean dishes.

The functional state of household appliances can be influenced by incorrect operation and/or signs of ageing or wear. For example, a vacuum cleaner can be put into operation by a user without a vacuum cleaner bag being inserted. A food processor, for example, can also be put into operation without a tool required for operation, in particular a blade, being inserted in the machine. In both cases, a faulty functional state of the household appliance in question results from incorrect operation by a user. The result intended by the user with regard to the operation of the household appliance is subsequently not achieved or not achieved with sufficient quality. Household appliances are also subject to ageing and wear mechanisms during operation. For example, a tool of a food processor, in particular a blade, can lose its sharpness with an increasing number of operating hours, as a result of which the chopping of food within the food processor becomes increasingly inefficient and the quality of the desired result deteriorates. With regard to a vacuum cleaner, the suction power can also decrease due to an increasingly full filter bag during regular operation of the vacuum cleaner. Mechanical parts, such as bearings, can also be affected by signs of wear, which can result in increased energy consumption of the household appliance and/or disturbing operating noises. If a faulty functional state is not detected at an early stage, this can also cause consequential damage if the household appliance in question continues to operate, which further impairs the safe and reliable operation of the household appliance in question.

It is therefore desirable to be able to define the functional state of a household appliance as easily and reliably as possible within a household environment, particularly with regard to its operational readiness. This allows wear-related failures and/or breakdowns or problems due to incorrect operation of the household appliance to be prevented at an early stage. The availability of the household appliance and its service life can thus be increased. A loss of quality due to ageing and/or use can also be reduced or avoided with regard to the work results that can be achieved with the household appliance.

It is therefore an object of the present invention to at least partially overcome at least one of the disadvantages described above. In particular, it is the object of the invention to provide a method for monitoring a functional state, in particular a functional state, of at least one household appliance, a monitoring system, a computer program product, a computer-readable storage medium and a data carrier signal, each of which enables an improved and/or simplified definition of a functional state of a household appliance within a household environment.

The foregoing problem is solved by a method according to a first aspect of the present invention, by a monitoring system according to a second aspect of the present invention, by a computer program product according to a third aspect of the present invention, by a computer-readable storage medium according to a fourth aspect of the present invention, and by a data carrier signal according to a fifth aspect of the present invention. Further features and details of the invention are apparent from the dependent claims, the description and the drawings. Features and details which are described in connection with the method according to the invention naturally also apply in connection with the monitoring system according to the invention and/or in connection with the computer program product according to the invention and/or in connection with the computer-readable storage medium according to the invention and/or in connection with the data carrier signal according to the invention and vice versa in each case, so that reference is or can always be made mutually with respect to the disclosure relating to the individual aspects of the invention.

According to the first aspect of the present invention, there is provided a method for monitoring a functional state of at least one household appliance in a household environment (meaning: environment in a household) by a monitoring system, wherein the monitoring system comprises at least one monitoring device, and wherein the method comprises at least the following:
Receiving an acoustic signal from the household environment in the monitoring device, in particular by a receiving device of the monitoring device,
Evaluation of the acoustic signal and provision of an evaluation data set, in particular by an evaluation device of the monitoring device and/or a central computer,
Identification of a household appliance in the household environment as the source of the acoustic signal as a function of the evaluation data set and provision of an appliance data set, in particular specific to the identified household appliance, in particular by an identification device of the monitoring device and/or a central computer and/or the household appliance,
Defining a, in particular current, functional state of the household appliance identified as the source of the acoustic signal as a function of the evaluation data set and the appliance data set, in particular by a state definition device of the monitoring device and/or a central computer.

In other words, a method is provided for monitoring a functional state of at least one household appliance located in a household environment. The monitoring is carried out by a monitoring system comprising at least one monitoring device.

It is intended that an acoustic signal from the household environment is received in the monitoring device. The acoustic signal can be received, for example, by at least one receiving device of the monitoring device.

It is also provided that the acoustic signal is evaluated and an evaluation data set is provided as a result of this evaluation. The acoustic signal can be evaluated at least partially by the monitoring device. Additionally or alternatively, the acoustic signal can be evaluated at least in part by a central server.

Depending on the evaluation data set, a household appliance in the household environment is also identified as the source (emitter) of the acoustic signal and an appliance data set is provided, whereby the appliance data set is preferably characteristic or specific for the household appliance identified as the source of the acoustic signal. The identification and/or provision of the appliance data set can be carried out in particular by an identification device of the monitoring device and/or a central computer.

To provide the appliance data set, appliance data for at least one household appliance can be stored on at least one household appliance and/or at least one monitoring device and/or at least one central server.

Additionally or alternatively, the appliance data set may be provided by the household appliance identified as the source of the acoustic signal and transmitted to the monitoring device and/or a central server. In this context, it is conceivable that at least one of the following is comprised by the method, in particular by the provision of the appliance data set:
Requesting an appliance data set from the household appliance identified as the source of the acoustic signal,
Transmitting the appliance data set from the household appliance identified as the source of the acoustic signal to the monitoring device and/or a central server.

Furthermore, it is provided that, depending on the evaluation data set and the appliance data set, a functional state, in particular the current functional state, of the household appliance identified as the source of the acoustic signal is defined. The functional status can preferably be defined by a state definition device of the monitoring device and/or a central computer.

The method according to the invention offers the advantage that acoustic signals emitted by household appliances in a household environment can be received and processed centrally by a monitoring device or communicated for further processing. Furthermore, based on the evaluation of the acoustic signals, a specific household appliance in the household environment can be defined as the source of the acoustic signal and its status can be defined. In particular, this makes it possible to reduce the hardware and/or software to be provided individually for household appliances in order to perform functional state monitoring, as the status monitoring is carried out centrally by one or more monitoring devices.

A functional state of a household appliance is to be understood here as a state that is characteristic of whether a household appliance can be operated fault-free or not. If a faulty functional state is present, this is characteristic of the fact that the household appliance cannot be operated fault-free. The presence of a faulty functional state does not fundamentally preclude the household appliance from being operated. In other words, not every faulty operating state must immediately result in a failure of the household appliance. A faulty functional state can manifest itself, for example, in increased and/or changed noise emissions, increased energy consumption, a loss of at least one performance parameter, e.g. a suction power, of the household appliance, a reduced quality of the work results that can be achieved by the household appliance or even an at least temporary failure of the household appliance.

With respect to the present invention, it is conceivable that individual stages of the method are carried out at least partially simultaneously. Additionally or alternatively, it is conceivable that at least individual stages of the method are performed or repeated recurrently. Additionally or alternatively, it may be provided that at least individual stages of the method are computer-implemented or that the method is a computer-implemented method.

The acoustic signal can be evaluated at least partially by the monitoring device. Additionally or alternatively, the acoustic signal can be evaluated at least partially by a central server. A combined evaluation of the acoustic signal, partly by the monitoring device and partly by the central computer, can also be provided. The evaluation data sets generated in the course of the respective evaluations can then, for example, be merged into a single evaluation data set. The evaluation within the monitoring device, in particular by at least one evaluation device, offers the advantage that a result can be provided to the monitoring device quickly and independently of the connection quality (e.g. in relation to the Internet or a mobile network). Evaluating the acoustic signal in a central computer offers the advantage that computing capacities for performing complex computing operations can be centralized. This allows the configuration of the monitoring device to be more compact and cost-effective.

With respect to an at least partial evaluation of the acoustic signal by a central computer, it may be provided that the method comprises at least one of the following:
Transmission of the acoustic signal from the monitoring device to a central computer, in particular by a communication device of the monitoring device,
Transmission of an evaluation data set from the central computer to the monitoring device, in particular to a communication device of the monitoring device.

The identification of a household appliance in the household environment as the source of the acoustic signal as a function of the evaluation data set may be performed at least in part by a central computer. In this context, it may be provided that the method comprises at least one of the following:
Transmission of the evaluation data set from the monitoring device to a central computer, in particular by a communication device of the monitoring device,
Transmission of an appliance data set from the central computer to the monitoring device, in particular to a communication device of the monitoring device.

In the context of the invention, it may be advantageous that the evaluation of the acoustic signal comprises at least one of the following:
Performing at least one filtering, in particular bandpass filtering, of the acoustic signal to remove at least one frequency part from the acoustic signal and providing at least one filtered acoustic signal, in particular in the evaluation data set,
Determining a frequency spectrum of at least one, in particular filtered, acoustic signal by frequency analysis of the, in particular filtered, acoustic signal and preferably providing the frequency spectrum in the evaluation data set,
Determining a sound pressure level information, wherein the sound pressure level information is characteristic for a sound pressure level of the acoustic signal and preferably providing the sound pressure level information in the evaluation data set,
Determining psychoacoustic information, wherein the psychoacoustic information is characteristic of at least one psychoacoustic quantity of the acoustic signal and preferably providing the psychoacoustic information in the evaluation data set.

A psychoacoustic parameter can preferably be one of the following:
A loudness of the acoustic signal,
A sharpness of the acoustic signal,
A tonality of the acoustic signal,
A roughness of the acoustic signal,
A tonal quality of the acoustic signal,
A pulse content of the acoustic signal,
A fluctuation strength of the acoustic signal.

By performing filtering, in particular bandpass filtering, a predetermined frequency range can be isolated from the acoustic signal. For example, with regard to a household appliance, it may be known that it predominantly emits sound in a specific frequency spectrum during operation. A different frequency range may be known for another household appliance. Accordingly, the respective frequency spectra can be used for bandpass filtering in order to remove interfering frequency parts from the acoustic signal in preparation for further evaluation.

Performing a frequency analysis allows an acoustic signal, in particular a filtered acoustic signal, to be transferred from the spatial domain to the frequency domain and a frequency spectrum of the signal to be provided, which is characteristic of the frequency parts contained in the signal. Based on the reference spectrum, a simplified comparison of the acoustic signal to known acoustic signals can be carried out. Based on a frequency spectrum and/or a sound pressure level, a simple comparison can be made with known data to reliably define the functional state of a household appliance.

In the context of the invention, it may be advantageous that the evaluation of the acoustic signal comprises at least one of the following:
Comparing the sound pressure level of the acoustic signal with at least one reference sound pressure level,
Ignore the acoustic signal if the sound pressure level of the acoustic signal is lower than or equal to the reference sound pressure level.

In other words, it may be provided that a determined sound pressure level of the acoustic signal is compared with a reference sound pressure level. If the sound pressure level of the acoustic signal corresponds to the reference sound pressure level, i.e. is equal to it, or falls below the reference sound pressure level, it may be provided that the acoustic signal is ignored. By ignoring the acoustic signal, it should be understood here that the method is aborted with regard to the processing of this acoustic signal, i.e. no further evaluation is carried out and no household appliance is identified or a functional state is defined on the basis of the acoustic signal. The advantage of this is that interfering noises in the household environment can be masked out in relation to the method at hand. This in turn makes it possible to reduce the computing effort involved, as unnecessary computing operations are avoided. Interfering noises can be, for example, noises that are emitted outside the household environment and penetrate it, such as interfering noise. As such disturbing noises are often quieter than the operation of household appliances within the household environment.

The recording and evaluation of psychoacoustic variables allows a detailed characterization of the acoustic signal, which simplifies the efficient and reliable identification of fault states.

Within the scope of the invention, it is conceivable that the evaluation of the acoustic signal comprises at least the following:
Determining localization information, wherein the localization information is characteristic of a direction and/or a distance of an origin location of the acoustic signal relative to the monitoring device and preferably providing the localization information in the evaluation data set.

In other words, it may be provided that a distance and/or a direction of an origin of the acoustic signal relative to the monitoring device is determined and preferably provided as part of a localization information in the evaluation data set. The advantage of determining localization information is that the point of origin of the acoustic signal can be compared with known positions in the household environment. This can simplify or support the identification of a household appliance in the household environment. For example, only household appliances located near the point of origin can be considered as potential sources of the acoustic signal. A place of origin of the acoustic signal should be understood as the location at which the acoustic signal was emitted, in particular by a household appliance, preferably in the household environment.

Furthermore, the determination of the localization information enables an improved interpretation of the acoustic signal in relation to the definition of a functional state of a household appliance in the household environment. The distance between the origin location of the acoustic signal and the monitoring device can have an influence on the characteristics of the acoustic signal received in the monitoring device. The influence can be used by knowing the localization information in the context of defining the functional state in order to increase the reliability in defining the functional state.

Within the framework of the invention, it may be provided that the monitoring device, in particular at least one receiving device of the monitoring device, comprises at least two receiving components, in particular arranged at a spatial distance from one another, wherein the determination of the localization information comprises at least the following:
Evaluating at least one transit time difference of the acoustic signal with respect to a receiving of the acoustic signal by the at least two receiving components for defining a direction and/or a distance of the origin of the acoustic signal relative to the monitoring device,
Entering a position of the point of origin on an environment map of the household environment, especially in real time.

In other words, at least one monitoring device, in particular at least one receiving device of at least one monitoring device, can have at least two receiving components for receiving the acoustic signal in the monitoring device. The at least two monitoring components can preferably be arranged at a spatial distance from one another in or on the monitoring device. There may be more than two receiving components, in particular at least three or at least four receiving components. At least one receiving component can be configured as a microphone. To define a direction and/or a distance of the point of origin of the acoustic signal relative to the monitoring device, a transit time difference of the acoustic signal in relation to its receiving by at least two receiving components can preferably be evaluated. A transit time difference is to be understood as the time delay of the receiving of the acoustic signal in the respective receiving components. In this way, the direction and distance of the point of origin of the acoustic signal relative to the monitoring device can be determined in a simple and cost-effective manner, in particular by acoustic triangulation.

Once the point of origin has been determined, it can be entered in the environment map, particularly in real time. For example, in the event that the environment map is displayed to a user, the position of the original location can be recognized by this user. The original location can be entered on a recurring basis. In other words, whenever a place of origin has been determined, it can be entered in the environment map or updated within the environment map.

It may further be provided within the scope of the invention that at least one of the following is comprised:
Display of the environment map by at least one monitoring device, in particular by a display device of the monitoring device,
Display the place of origin on the environment map,
Display at least one household appliance in the environment map.

By entering the position of the origin location and/or at least one household appliance on an environment map, it can be made visually clear to a user where the origin location of the acoustic signal is. This makes it possible, for example, to easily enable or receive assistance from the user in identifying a household appliance as the source of the acoustic signal in the household environment.

A household environment should be understood here as a spatially limited household. For example, a household environment can be an apartment or a house. In particular, a household environment can preferably comprise at least one room or several rooms, in particular living rooms. An environment map should also be understood as an image, in particular a parameterized image, of the household environment. The environment map can preferably comprise a room layout of the household environment. Additionally or alternatively, the environment map may comprise the position of at least one monitoring device in the household environment. By parameterizing the household environment in the form of an environment map, the environment map can be used both in the course of data processing and, for example, shown on a display.

It is also conceivable that at least one of the following is comprised:
Determining an environment map of a household environment, in particular by at least one household appliance and/or at least one monitoring device,
Determining at least one piece of information about a floor covering in at least one area or at at least one position within the household environment and, in particular, entering this information about the floor covering in the environment map.

In other words, it may be provided that the method comprises determining an environment map of the household environment. The environment map can be determined at least in part by at least one household appliance. For example, the household environment can be scanned by a robot vacuum cleaner and measured or parameterized. Additionally or alternatively, the environment map can be determined at least partially by at least one monitoring device. For example, sound signals can be emitted into the household environment by the monitoring device and reflections of these sound signals (echoes) can be evaluated in order to identify boundaries of the household environment or its distance from the monitoring device.

Additionally or alternatively, it may be provided that at least one piece of information about a floor covering is determined in at least one area or at at least one position within the household environment. This information can preferably be stored in the environment map of the surroundings.

The floor covering can be determined at at least one position within the household environment in different ways. For example, the determination can be carried out at least partially by a household appliance that is configured to identify a floor covering type. Additionally or alternatively, a floor covering in at least one area of the household environment can be defined by a user (user input). Additionally or alternatively, it may be provided that a floor covering is determined by at least one monitoring device, in particular by evaluating at least one acoustic signal from a household appliance. This makes use of the knowledge that a household appliance, e.g. a vacuum cleaner, has a specific noise characteristic depending on the floor covering on which it is used.

It is also conceivable that the evaluation of the acoustic signal comprises at least the following:
Determining at least one piece of shading information, the shading information being characteristic of a shading of the monitoring device by at least one shading element in the household environment in relation to the point of origin of the acoustic signal, and preferably providing the shading information in the evaluation data set.

The determination of shading information enables an improved interpretation of the acoustic signal in relation to the definition of a functional state of a household appliance in the household environment. For example, a shading element located between the point of origin of the acoustic signal and the monitoring device can have an influence on the characteristics of the acoustic signal received in the monitoring device. The influence can be used by knowing the shading information as part of the definition of the functional state in order to increase the reliability of the definition of the functional state.

At least one shading element can preferably be configured as a wall. The wall can preferably be an interior wall in the household environment. At least one shading element can also be configured as a piece of furniture, in particular as a cabinet. Additionally or alternatively, at least one piece of shading information may comprise at least one piece of material information, wherein the material information is characteristic of a material of the shading element. As an example, a wall in the household environment can be a drywall or a brick wall. Since different materials influence the characteristics of the acoustic signal in different ways, this can further increase the reliability in defining the functional state.

It is also conceivable that the determination of at least one piece of shading information comprises at least the following:
Comparing the localization information with an environment map of the household environment, wherein the environment map comprises a position and/or size of at least one shading element and a position of the monitoring device in the household environment.

In other words, it may be provided that the localization information is compared with the environment map of the household environment in order to determine the shading information. In this respect, a comparison should be understood to mean in particular that a check is performed as to whether the receiving of the acoustic signal by the monitoring device is influenced by a shading element. In other words, it is checked whether the acoustic signal has to pass or penetrate at least one shading element before reaching the monitoring device.

The environment map preferably comprises the position and/or size and/or material information of at least one shading element and a position of the monitoring device in the household environment. Thus, using the localization information, it is possible to check whether or not the acoustic signal is shadowed by at least one shading element in relation to a receiving of the acoustic signal in the monitoring device. This makes it easy to determine which shading elements in the household environment need to be taken into account with regard to the change in a characteristic of the acoustic signal.

Shading of the acoustic signal by a shading element in relation to the receiving of the acoustic signal in the monitoring device should be understood here to mean that the acoustic signal must penetrate or pass through the shading element before it reaches the monitoring device.

Within the scope of the invention, it is optionally possible that the evaluation of the acoustic signal comprises at least the following:
Determining at least one piece of floor covering information, the floor covering information being characteristic of a floor covering in at least one area of the household environment, in particular at the point of origin of the acoustic signal, and preferably providing the floor covering information in the evaluation data set.

The determination of floor covering information enables an improved interpretation of the acoustic signal in relation to the definition of a functional state of a household appliance in the household environment. For example, different floor coverings in the household environment can influence the characteristics of the acoustic signal emitted by the household appliance. For example, the noise produced by a vacuum cleaner on a carpeted floor differs from the noise produced by a vacuum cleaner operating on a tiled or wooden floor. This influence can be used by knowing the floor covering information when defining the functional state in order to increase the reliability of the functional state defining.

Furthermore, it may be provided within the scope of the invention that the determination of at least one floor covering information comprises at least the following:
Comparing the localization information, in particular the point of origin of the acoustic signal, with an environment map of the household environment, the environment map comprising at least one piece of information about a floor covering in at least one area of the household environment.

In other words, it may be provided that the localization information is compared with the environment map of the household environment in order to determine the floor covering information. In this respect, a comparison should be understood to mean in particular that a check is performed as to which floor covering is present at the position identified as the origin of the acoustic signal within the household environment.

The environment map preferably comprises information about a floor covering in at least one area or at at least one position within the household environment as well as a position of the monitoring device in the household environment. In this way, the localization information can be used to check which floor covering is present at the origin location of the acoustic signal.

In relation to the present invention, it is conceivable that identifying a household appliance in the household environment comprises at least one of the following:
Comparing the localization information with an environment map of the household environment, wherein the environment map of the environment comprises a position of at least one household appliance and a position of the monitoring device in the household environment,
Evaluation of at least one user input from a user of the monitoring system,
Transmitting at least one operation request from at least one monitoring device and/or a central server to at least one household appliance,
Transmitting at least one piece of operating information from at least one household appliance to at least one monitoring device and/or a central server, the operating information being characteristic of whether the household appliance was in operation in relation to the time of receiving of the acoustic signal in the monitoring device.

In other words, to identify a household appliance as the source of the acoustic signal in the household environment, at least one comparison of the localization information with the environment map of the household environment may be provided. The environment map preferably comprises a position of at least one household appliance and a position of the monitoring device in the household environment. In this way, the localization information can be used to check which household appliance is located in the vicinity of the origin location or at the origin location of the acoustic signal, which can simplify the identification of a household appliance as the source of the acoustic signal. Additionally or alternatively, at least one user input from a user of the monitoring system can be evaluated to identify the household appliance as the source of the acoustic signal. For example, it is possible to query whether a household appliance determined on the basis of the localization information is currently in operation or has recently been in operation. For example, a household appliance can be additionally verified as the source of the acoustic signal. Such a user input can be performed, for example, via the monitoring device and/or a mobile appliance of the monitoring system.

Additionally or alternatively, an operating request may be transmitted from a monitoring device or a central server to a household appliance. For example, a group of household appliances may have been identified as possible sources of the acoustic signal on the basis of the localization information. This can happen in particular if several household appliances are located in close proximity in the household environment. In response to the operating request, the relevant household appliances can transmit operating information to the central server or the monitoring device. The operating information is characteristic of whether the household appliance was in operation at the time the acoustic signal was received in the monitoring device. If the household appliance was not in operation, it can be excluded as a potential source of the acoustic signal.

The appliance data set can preferably be an appliance data set for the acoustic appliance identified as the source of the acoustic signal. Additionally or alternatively, it is conceivable that at least one appliance data set comprises at least one of the following parameters:
An appliance type and/or model identifier of the household appliance,
An age of the household appliance,
An operating history of the household appliance,
A maintenance history and/or damage history of the household appliance.

A model identifier as a parameter should be characteristic of a specific type of household appliance. The model identifier can thus be used to clearly define the type or model of the household appliance identified as the source of the acoustic signal. An operating history of the household appliance as a parameter can preferably be at least characteristic of the previous operating hours of a household appliance. A maintenance history as a parameter can preferably be at least characteristic of at least one maintenance performed on the household appliance. A damage history as a parameter can preferably be at least characteristic of a past or existing damage to the household appliance.

An age of the household appliance and/or an operating history of the household appliance and/or a maintenance history and/or a damage history as a parameter enables an improved interpretation of the acoustic signal in relation to the definition of a functional state of a household appliance in the household environment. For example, signs of ageing or damage can have an influence on the characteristics of the acoustic signal emitted by the household appliance. Maintenance and repairs can also at least partially compensate for this influence. Precise knowledge of the above-mentioned aspects can therefore be used to define the functional state of the household appliance more reliably.

In the context of the invention, it may be advantageous that defining a functional state of the household appliance comprises at least one of the following:
Provision of at least one comparison frequency spectrum by an appliance knowledge base, in particular as a function of the evaluation data set and/or the appliance data set, and determination of a frequency deviation between the comparison frequency spectrum and the frequency spectrum of the acoustic signal,
Provision of at least one comparative sound pressure level by an appliance knowledge base, in particular as a function of the evaluation data set and/or the appliance data set, and determination of a level deviation between the comparative sound pressure level and the sound pressure level of the acoustic signal,
Provision of at least one psychoacoustic comparison variable by an appliance knowledge base, in particular as a function of the evaluation data set and/or the appliance data set, and determination of at least one psychoacoustic deviation between the psychoacoustic comparison variable and at least one psychoacoustic variable of the acoustic signal,
Defining the functional state of the household appliance as a function of the frequency deviation and/or the level deviation and/or at least one psychoacoustic deviation, in particular through a state knowledge base.

In other words, it may be provided that, depending on the evaluation data set and the appliance data set, at least one comparison frequency spectrum and/or at least one comparison sound pressure level and/or at least one psychoacoustic comparison variable is provided by an appliance knowledge base. The appliance knowledge base represents a functional relationship between the appliance data set and/or the evaluation data set on the one hand and at least one comparison frequency spectrum and/or at least one comparison sound pressure level and/or at least one psychoacoustic comparison variable on the other hand. In other words, at least the appliance data set and the evaluation data set, in particular the information or parameters covered by the evaluation data set and/or appliance data set, are used as input parameters of the appliance knowledge base. Depending on the input parameters, the appliance knowledge base provides at least one comparison frequency spectrum and/or at least one comparison sound pressure level as output parameters.

It may be provided that for each psychoacoustic variable of the acoustic signal detected or contained in the psychoacoustic information, a corresponding psychoacoustic comparison variable is provided and a psychoacoustic deviation is determined.

The appliance knowledge base can comprise a database in which at least one comparison frequency spectrum, in particular a plurality of comparison frequency spectra, and/or at least one comparison sound pressure level, in particular a plurality of comparison sound pressure levels, is or are stored. The comparison frequency spectra and/or comparison sound pressure levels can be stored as a function of various input parameters. In this way, suitable comparison frequency spectra or comparison sound pressure levels can be provided in response to variable input parameters. In other words, comparison frequency spectra and/or comparison sound pressure levels for different household appliances are stored in the appliance knowledge base for variable distances between the household appliance and a receiver of an acoustic signal emitted by the household appliance and/or variable shading conditions of the household appliance and/or different floor coverings on which the household appliance is operated and/or different ages of the household appliance.

A frequency deviation between the frequency spectrum of the, in particular filtered, acoustic signal can be determined on the basis of a reference frequency spectrum. The frequency deviation can preferably be characteristic of an amplitude deviation between the reference frequency spectrum and the frequency spectrum of the acoustic signal. Additionally or alternatively, a sound pressure level deviation can be determined on the basis of a reference sound pressure level.

Furthermore, the functional state of the household appliance can be determined as a function of at least one frequency deviation and/or at least one amplitude deviation. In particular, the functional state of the household appliance can be defined and/or provided by a state knowledge base at least as a function of at least one frequency deviation and/or at least one level deviation. The state knowledge base thereby represents a functional relationship between a level deviation and/or frequency deviation and at least one potential fault state of at least one household appliance, in particular household appliance type. In other words, at least one frequency deviation and/or at least one level deviation are used as input parameters of the state knowledge base. Depending on the input parameters, the state knowledge base provides a functional state of the household appliance output parameters. Preferably, the appliance data set and/or localization data set can also be used as input parameters for the state knowledge base or the functional state can also be determined as a function of the appliance data set and/or localization data set. By using the appliance data set, for example, the functional state searched for can be concretized for a specific household appliance type. Furthermore, the information contained in the appliance data set and/or localization data set can have an influence on the characteristics of a frequency or level deviation.

The state knowledge base can comprise a database in which at least one frequency deviation and/or level deviation is stored for at least one functional state, in particular a plurality of functional states, of at least one household appliance. Based on a comparison of a determined level deviation or frequency deviation with the level or frequency deviations contained in the state knowledge base, a functional state of the household appliance can thus be determined. In addition or alternatively, the state knowledge base can comprise at least one neural network, in particular the neural network forming the functional relationship between a level deviation and/or frequency deviation and at least one potential fault state of at least one household appliance, in particular household appliance type. The state knowledge base can also comprise several neural networks, in particular each neural network being characteristic of a specific household appliance type.

At least one neural network may have been trained with training data, in particular the training data comprising at least one training data set, in particular a plurality of training data sets. Preferably, at least one training data set may comprise at least one of the following:
An appliance data set,
An evaluation data set,
A frequency deviation,
A level deviation,
A functional state.

In this way, the neural network can be given or taught a specific functional state depending on an appliance data set and/or evaluation data set and/or a frequency deviation and/or a level deviation. By taking an appliance data set into account, the training can be specified for a specific household appliance type or other parameters such as the age of the household appliance or an operating history can be taken into account during training. By taking into account the one evaluation data set, further aspects such as the removal of the household appliance, the shading of the household appliance or the floor covering can be taken into account during training.

Within the scope of the invention, it may be provided that at least one is characteristic of at least one of the following states:
Fault-free or faulty operation of the household appliance,
The absence of at least one accessory of the household appliance,
A state of wear of at least one component and/or at least one accessory of the household appliance.

With regard to a vacuum cleaner, faulty operation of a household appliance can be characterized, for example, by a full vacuum cleaner bag. In this case, the appliance is basically not damaged and functional. However, a cleaning operation with the household appliance in question will not deliver the desired quality of results.

The absence of at least one accessory can be, for example, the absence of a vacuum cleaner bag in relation to a vacuum cleaner. In relation to a food processor, the absence of an accessory may, for example, be the absence of a tool, in particular a blade.

A state of wear can be, for example, a state of wear of a motor, in particular a drive motor, fan, loudspeaker or another accessory of the household appliance (e.g. a blade of a food processor or a brush of a vacuum cleaner). Accordingly, based on the state of wear, it is possible to determine whether and when maintenance measures are required on the household appliance in question.

The appliance knowledge base and the state knowledge base can preferably be configured as a combined knowledge base as parameters. At least one knowledge base as a parameter can be stored on a data memory, in particular a non-volatile data memory, and can be reused.

It may be provided within the scope of the invention that at least one of the following is comprised by the method:
Transmitting at least one functional state from at least one monitoring device and/or a central server to at least one mobile appliance.

It may be advantageous is that a user of the monitoring system can be informed of any malfunctions of individual household appliances at an early stage. In this way, the user can initiate appropriate measures to procure spare parts, perform maintenance or ensure proper operation and effectively prevent consequential damage to the household appliances.

The above object is further solved by a monitoring system according to the invention for monitoring a functional state of at least one household appliance according to the second aspect of the present invention. The monitoring system comprises at least one monitoring device, wherein preferably the monitoring system is operated according to a method according to the first aspect of the present invention, in particular according to a method according to any one of claims 1 to 11.

This results in the same advantages with regard to a monitoring system according to the invention as have already been described with regard to a method according to the invention.

Within the scope of the invention, it may be provided that at least one monitoring device is stationary, in particular fixed, within the household environment. Additionally or alternatively, it may be provided that the monitoring system comprises at least one household appliance, with the monitoring device being integrated into the household appliance. By integration of a monitoring device into a household appliance, meaning that the monitoring device is built into or connected to the household appliance. In other words, the monitoring device forms an integral part of the household appliance. In particular, the household appliance in which the monitoring device is integrated can be monitored by the monitoring system or the monitoring device and/or other household appliances in the household environment.

Within the scope of the invention, it may further be provided that the monitoring system comprises at least one household appliance, wherein in particular the household appliance can be brought at least temporarily into a communication connection with at least one monitoring device and/or a central server.

Within the scope of the invention, it may be provided that the monitoring system comprises more than one monitoring device. In particular, the monitoring system may comprise at least two or at least four or at least six monitoring devices. The advantage of using more than one monitoring device is that a larger household environment can be covered in an improved way. For example, at least one monitoring device can be placed in each of at least two or all separate rooms in the household environment. In this way, acoustic signals from the household appliances operating in the rooms in question can be received by the respective monitoring devices in an unaltered or essentially unaltered form and the quality of the results in terms of defining the functional state of the household appliance in question can be improved.

Within the scope of the invention, it may be provided that at least one monitoring device is configured as a tablet, a notebook, a smartphone or a smart speaker.

At least one monitoring device may preferably comprise at least one of the following:
At least one receiving device,
At least one evaluation device,
At least one identification device,
At least one state definition device,
At least one communication device,
At least one display device,
At least one voice input device,
At least one acoustic device.

At least two devices from the group of receiving device, evaluation device, display device, voice input device, acoustic device, identification device, communication device and state definition device can be configured as a common device. This results in the advantage of a comparatively compact and cost-effective configuration of a monitoring device. In addition or alternatively, at least one monitoring device, in particular at least one device from the group of receiving device, evaluation device, acoustic device, display device, voice input device, communication device, identification device and state definition device, can comprise elements for data processing. The elements for data processing can comprise at least one computing device, in particular at least one processor, and/or at least one working memory and/or at least one, preferably non-volatile, data memory. Additionally or alternatively, it is conceivable that the data processing elements are configured to carry out at least individual stages of a method according to the first aspect of the present invention, in particular a method according to the first aspect of the present invention.

At least one display device can preferably comprise at least one, in particular touch-sensitive, display, whereby information for a user can be shown in particular via the display. In particular, an environment map of the household environment can be displayed by at least one display of the display device. Household appliances and/or events located in the household environment, such as the origin of an acoustic signal, can also be displayed on the environment map. By using a touch-sensitive display, the advantage can be achieved that inputs from a user to the monitoring device can be received by the display device. In particular, positions on the environment map of the surroundings can be marked by a user. Additionally or alternatively, instructions and/or questions can be displayed to the user, to which the user can react or respond by making appropriate inputs.

At least one voice input device can comprise at least one receiving component, in particular at least one microphone. The voice input device can be used in particular to receive and evaluate voice user input in the monitoring device.

At least one acoustic device can preferably comprise at least one loudspeaker for emitting acoustic signals into the household environment. An acoustic device can be used to transmit acoustic indications from the monitoring device to the household environment. This can, for example, alert a user of the monitoring system to a fault state of a household appliance. Additionally or alternatively, a user can be prompted to make a user input.

At least one receiving device can preferably comprise at least one, in particular at least two or at least three or at least four receiving components for receiving the acoustic signal. At least one receiving component can preferably be configured as a microphone.

At least one communication device can preferably comprise at least one, in particular wireless, communication interface. At least one communication interface can, for example, be configured as a Bluetooth interface, WLAN interface or mobile phone interface. The communication interface can be used to communicate data from the monitoring device to a central computer or a mobile appliance, for example, or to receive and provide data from a mobile appliance or a central computer in the monitoring device.

It is also conceivable within the scope of the invention that the monitoring system comprises at least one central server. At least one central server can be configured as a cloud system. At least one central computer may comprise at least one communication interface. In particular, at least one central computer can comprise a mobile phone interface and/or a network interface, in particular an Internet interface, so that data can preferably be transmitted to the central computer via mobile radio or at least one network, in particular the Internet.

Within the scope of the invention, it may advantageously be provided that the monitoring system comprises at least one mobile appliance. At least one mobile appliance can preferably be configured as a tablet, a smartphone, a smartwatch or a laptop. At least one mobile appliance can preferably comprise at least one, in particular wireless, communication interface. At least one communication interface can, for example, be configured as a Bluetooth interface, WLAN interface or mobile phone interface.

With reference to the present invention, it may be provided that at least one household appliance is configured as a cleaning robot or vacuum cleaner, in particular a vacuum cleaner robot, or as a kitchen machine or as an oven or as a washing machine or as a laundry dryer or as a dishwasher or as a hair dryer. In addition or alternatively, it may be provided that at least one household appliance has at least one communication interface, wherein in particular the household appliance can be brought, at least temporarily, into a, preferably bidirectional, communication connection with at least one monitoring device via the communication interface. For example, an appliance data set or operating information can be transmitted to the monitoring device or requests from the monitoring device can be received in the household appliance.

The above problem is further solved by a computer program product according to the third aspect of the present invention. The computer program product comprising instructions for causing a monitoring system according to the second aspect of the present invention, in particular according to any one of claim 13 or 14, to perform the stages of the method according to the first aspect of the present invention, in particular the stages of the method according to any one of claims 1 to 11.

This results in the same advantages with respect to a computer program product according to the invention as have already been described with respect to a method according to the invention and/or a monitoring system according to the invention.

The above problem is further solved by a computer-readable storage medium according to the fourth aspect of the present invention, wherein a computer program product according to the third aspect of the present invention, in particular according to claim 15, is stored on the computer-readable storage medium.

This results in the same advantages with respect to a computer-readable storage medium according to the invention as have already been described with respect to a method according to the invention and/or a monitoring system according to the invention and/or a computer program product according to the invention.

The above problem is further solved by a data carrier signal according to the fifth aspect of the present invention, wherein the data carrier signal transmits a computer program product according to the third aspect of the present invention, in particular a computer program product according to claim 15.

This results in the same advantages with respect to a data carrier signal according to the invention as have already been described with respect to a method according to the invention and/or a monitoring system according to the invention and/or a computer program product according to the invention and/or a computer-readable storage medium according to the invention.

Further advantages, features and details of the invention are shown in the following description, in which several embodiments of the invention are described in detail with reference to the drawings. The features mentioned in the claims and in the description may each be essential to the invention individually or in any combination. It shows

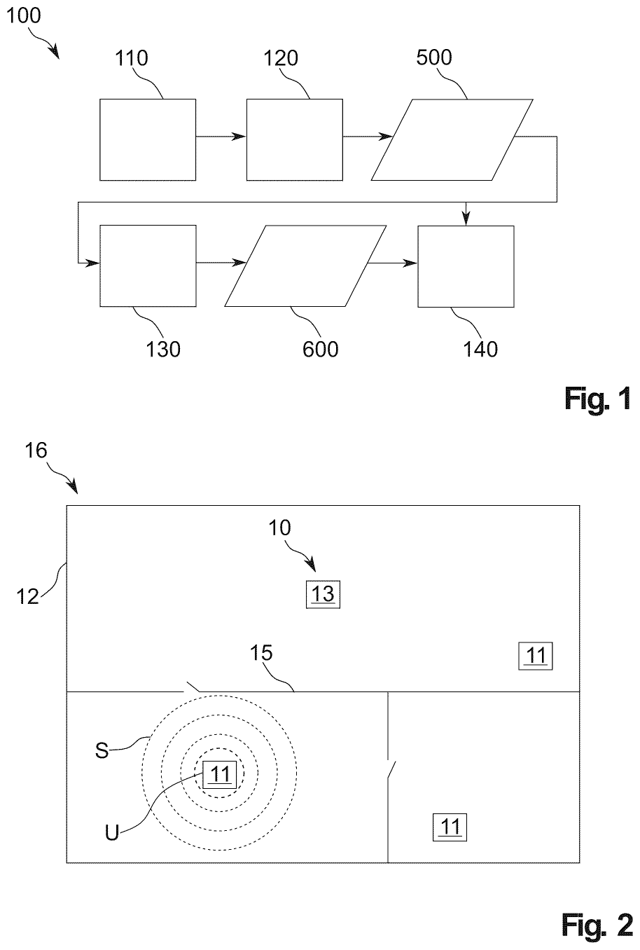

FIG. 1A schematic view of a method,

FIG. 2A schematic view of an environment map,

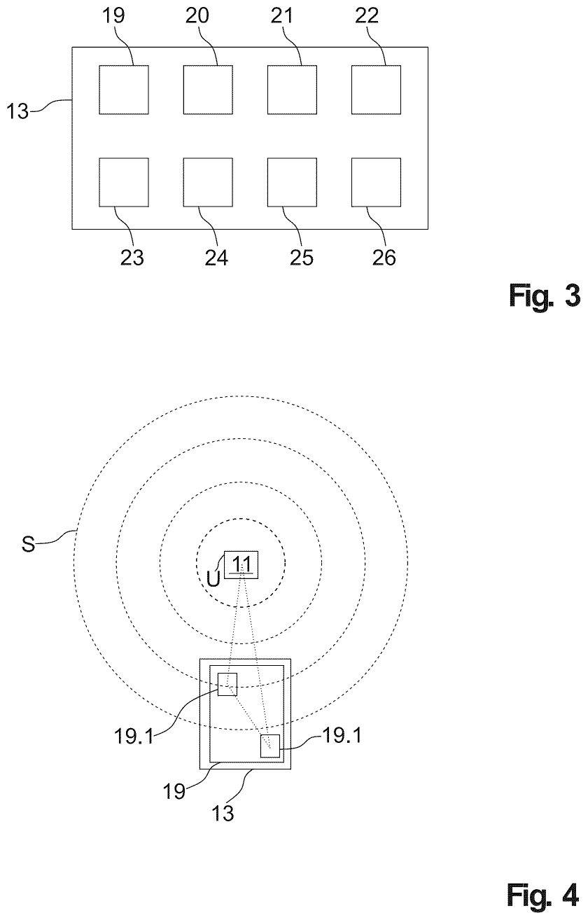

FIG. 3A schematic view of a monitoring device,

FIG. 4A schematic view of an acoustic triangulation,

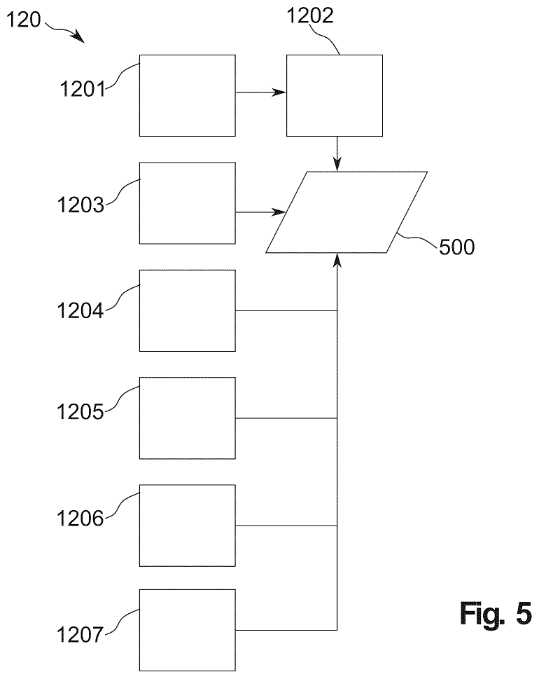

FIG. 5A schematic view of a method,

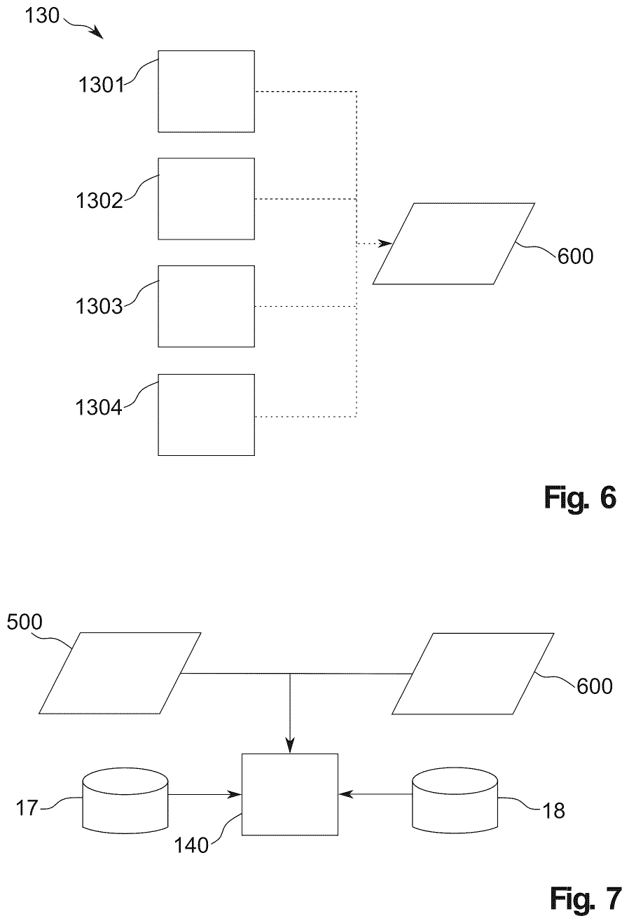

FIG. 6A schematic view of a method,

FIG. 7A schematic view of a method and

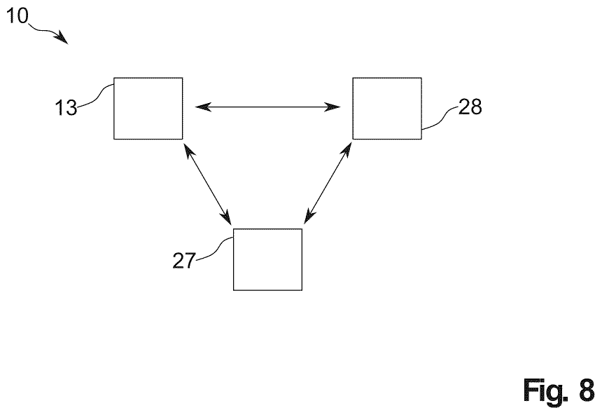

FIG. 8 a schematic view of a monitoring system.

In the figures, the identical reference symbols are used for the same technical features, even in different embodiments.

FIG. 1 shows a schematic view of a method 100 for monitoring a functional state of at least one household appliance 11 in a household environment 12 by a monitoring system 10 comprising at least one monitoring device 13, comprising the method 100:
Receiving 110 an acoustic signal S from the household environment 12 in the monitoring device 13,
Evaluating 120 the acoustic signal S and providing an evaluation data set 500,
Identifying 130 a household appliance 11 in the household environment 12 as the source of the acoustic signal S depending on the evaluation data set 500 and providing an appliance data set 600,
Defining 140 a functional state of the household appliance 11 as a function of the evaluation data set 500 and the appliance data set 600.

FIG. 2 also shows a schematic view of an environment map 16 of a household environment 12. In the present case, the household environment 12 comprises three rooms. Various household appliances 11 and a monitoring system 10 are arranged in the household environment 12, wherein the monitoring system 10 comprises at least one monitoring device 13.

An exemplary configuration of a monitoring device 13 is shown schematically in FIG. 3, where it can be seen that the monitoring device 13 comprises the following:
At least one receiving device 19,
At least one evaluation device 20,
At least one identification device 21,
At least one state definition device 22,
At least one communication device 23,
At least one display device 24,
At least one voice input device 25,
At least one acoustic device 26.

With reference to FIG. 2, it can be seen that at least one household appliance 11 emits an acoustic signal S within the household environment 12. Starting from the position of the household appliance 11 in the household environment 12, which thus forms the point of origin U of the acoustic signal S, the acoustic signal S propagates in the direction of the monitoring device 13 and can be received by the latter. In order to reach the monitoring device 13, the acoustic signal S must penetrate a wall, which thus acts as a shading element 15 with respect to the receiving of the acoustic signal S by the monitoring device 13.

FIG. 4 shows a schematic view of an acoustic triangulation for defining a direction and/or a distance of the point of origin U of the acoustic signal S relative to the monitoring device 13. The proportions are shown purely schematically (as in other figures). It can be seen that the monitoring device 13 comprises a receiving device 19, wherein the receiving device 19 comprises at least two receiving components 19.1 which are arranged spatially spaced apart from one another. Accordingly, the transit time differences of the acoustic signal S can be used to determine the direction from which the acoustic signal S has hit the respective receiving component 19.1, knowing the positional displacement between the receiving devices 19.1. The intersection of these directions emanating from the respective receiving components 19.1 forms the point of origin U of the acoustic signal S. This is indicated schematically by the dotted triangle shown in FIG. 4.

FIG. 5 also schematically shows a procedure for evaluating 120 the acoustic signal S, comprising the following:
Performing (1201) at least one filtering, in particular bandpass filtering, of the acoustic signal S to remove at least one frequency part from the acoustic signal S and providing at least one filtered acoustic signal S, in particular in the evaluation data set 500,
Determining (1202) a frequency spectrum of at least one, in particular filtered, acoustic signal S by a frequency analysis of the, in particular filtered, acoustic signal S and preferably providing the frequency spectrum in the evaluation data set 500,
Determining (1203) a sound pressure level information, wherein the sound pressure level information is characteristic of a sound pressure level of the acoustic signal S, and preferably providing the sound pressure level information, in the evaluation data set 500,
Determining (1204) localization information, wherein the localization information is characteristic of a direction and/or a distance of an origin location U of the acoustic signal S relative to the monitoring device 13, and preferably providing the localization information in the evaluation data set 500,
Determining (1205) at least one shading information, wherein the shading information is characteristic of a shading of the monitoring device 13 by at least one shading element 15 in the household environment 12 with respect to the origin location U of the acoustic signal S, and preferably providing the shading information in the evaluation data set 500,
Determining (1206) at least one floor covering information, wherein the floor covering information is characteristic of a floor covering in at least one area of the household environment 12, in particular at the point of origin U of the acoustic signal S, and preferably providing the floor covering information in the evaluation data set 500,
Determining (1207) psychoacoustic information, wherein the psychoacoustic information is characteristic of at least one psychoacoustic quantity of the acoustic signal S and providing the psychoacoustic information in the evaluation data set 500.

The information determined in the course of the above stages is then provided in an evaluation data set 500.

FIG. 6 further schematically shows a procedure for identifying 130 a household appliance 11 in the household environment 12 as the source of the acoustic signal S, wherein the following are comprised:
Comparing 1301 a localization information with an environment map 16 of the household environment 12, wherein the environment map 16 comprises a position of at least one household appliance 11 and a position of the monitoring device 13 in the household environment 12,
Evaluating 1302 at least one user input from a user of the monitoring system 10,
Transmitting 1303 at least one operation request from at least one monitoring device 13 and/or a central server to at least one household appliance,
Transmitting 1304 at least one operation information from at least one household appliance 11 to at least one monitoring device 13 and/or a central server, wherein the operation information is characteristic of whether the household appliance 11 was in operation in relation to the time of receiving of the acoustic signal S in the monitoring device 13.

Based on the information determined in the above stages, a household appliance 11 can be identified as the source of the acoustic signal S and a household appliance-specific appliance data set 600 can be provided accordingly, which is shown in FIG. 6 by the dashed lines.

FIG. 7 also schematically shows a procedure for defining 140 a functional state of the household appliance 11 as a function of the evaluation data set 500 and the appliance data set 600, wherein the following is comprised:
Provision of at least one comparison frequency spectrum by an appliance knowledge base 17 as a function of the evaluation data set 500 and/or the appliance data set 600, and determining a frequency deviation between the comparison frequency spectrum and the frequency spectrum of the acoustic signal S,
Provision of at least one comparative sound pressure level by an appliance knowledge base 17, in particular as a function of the evaluation data set 500 and/or the appliance data set 600, and determination of a level deviation between the comparative sound pressure level and the sound pressure level of the acoustic signal S,
Provision of at least one psychoacoustic comparative variable by an appliance knowledge base 17, in particular as a function of the evaluation data set 500 and/or the appliance data set 600, and determination of at least one psychoacoustic deviation between the psychoacoustic comparative variable and at least one psychoacoustic variable of the acoustic signal S,
Defining 140 the functional state of the household appliance 11 as a function of the frequency deviation and the level deviation and at least one psychoacoustic deviation by a state knowledge base 18.

FIG. 8 also shows a schematic view of a monitoring system 10, comprising at least one monitoring device 13, at least one central computer 27 and at least one mobile appliance 28, wherein the said components can be brought at least temporarily into a, in particular bidirectional, communication connection. In this way, data and information can be exchanged between the central computer 27, the mobile appliance 28 and the monitoring device 13.

### LIST OF REFERENCE SYMBOLS

10 Monitoring system
11 Household appliance
12 Household environment
13 Monitoring device
15 Shading element
16 Environment map
17 Appliance knowledge base
18 State knowledge base
19 Receiving device
19.1 Receiving component
20 Evaluation device
21 Identification device
22 State definition device
23 Communication device
24 Display device
25 Voice input device
26 Acoustic device
27 Central computer
28 Mobile appliance
100 Method
110 Receive
120 Evaluate
1201 Perform
1202 Determine
1203 Determine
1204 Determine
1205 Determine
1206 Determine
1207 Determine
130 Identify
1301 Comparing
1302 Evaluate
1303 Transmit
1304 Transmit
140 Define
500 Evaluation data set
600 Appliance data set
S Acoustic signal
U Place of origin

1. A method for monitoring a functional state of at least one household appliance in a household environment by a monitoring system comprising at least one monitoring device, the method comprising:
receiving an acoustic signal from the household environment in the monitoring device,
evaluating the acoustic signal and providing an evaluation data set,
identifying a household appliance in the household environment as the source of the acoustic signal in dependence on the evaluation data set and providing an appliance data set,
defining a functional state of the household appliance as a function of the evaluation data set and the appliance data set.

2. The method according to claim 1,
wherein
the evaluation of the acoustic signal comprises at least one of the following:
performing at least one filtering, in particular bandpass filtering, of the acoustic signal to remove at least one frequency part from the acoustic signal and providing at least one filtered acoustic signal
determining a frequency spectrum of at least one acoustic signal by a frequency analysis of the acoustic signal,
determining sound pressure level information, wherein the sound pressure level information is characteristic of a sound pressure level of the acoustic signal
determining psychoacoustic information, wherein the psychoacoustic information is characteristic of at least one psychoacoustic quantity of the acoustic signal.

3. The method according to claim 1,
wherein
the evaluation of the acoustic signal comprises at least the following:
determining localization information, wherein the localization information is characteristic of at least a direction or a distance of an origin location of the acoustic signal relative to the monitoring device.

4. The method according to claim 3,
wherein
the monitoring device comprises at least two receiving components wherein the determination of the localization information comprises at least the following:
evaluating of at least one transit time difference of the acoustic signal with respect to a receiving of the acoustic signal by the at least two receiving components for defining at least a direction or a distance of the point of origin of the acoustic signal relative to the monitoring device,
entering a position of the point of origin on an environment map of the household environment.

5. The method according to claim 1,
wherein
the evaluation of the acoustic signal comprises at least the following:
determining at least one shading information, the shading information being characteristic of a shading of the monitoring device by at least one shading element in the household environment with respect to the point of origin of the acoustic signal.

6. The method according to claim 5,
wherein
the determination of at least one piece of shading information comprises at least the following:
comparing of the localization information with an environment map of the household environment, wherein the environment map comprises at least a position and/or size of at least one shading element and a position of the monitoring device in the household environment.

7. The method according to claim 1,
wherein
the evaluation of the acoustic signal comprises at least the following:
determining at least one piece of floor covering information, the floor covering information being characteristic of a floor covering in at least one area of the household environment.

8. The method according to claim 7,
wherein
the determination of at least one floor covering information comprises at least the following:
comparing of the localization information, with an environment map of the household environment, wherein the environment map comprises at least one piece of information about a floor covering in at least one area of the household environment.

9. The method according to claim 1,
wherein
identifying a household appliance in the household environment as a source of the acoustic signal comprises at least one of the following:
comparing the localization information with an environment map of the household environment, wherein the environment map comprises a position of at least one household appliance and a position of the monitoring device in the household environment,
evaluating at least one user input from a user of the monitoring system,
transmitting at least one operation request at least from at least one monitoring device or a central server to at least one household appliance,
transmitting at least one piece of operating information from at least one household appliance at least to at least one monitoring device and/or a central server, the operating information being characteristic of whether the household appliance was in operation in relation to the time of receiving of the acoustic signal in the monitoring device.

10. The method according to claim 1,
wherein
the appliance data set comprises at least one of the following parameters:
at least an appliance type or model identifier of the household appliance,
an age of the household appliance,
an operating history of the household appliance,
at least a maintenance history or damage history of the household appliance.

11. The method according to claim 1,
wherein
the defining of a functional state of the household appliance comprises at least one of the following:
providing of at least one comparison frequency spectrum by an appliance knowledge base and determination of a frequency deviation between the comparison frequency spectrum and the frequency spectrum of the acoustic signal,
providing of at least one comparative sound pressure level by an appliance knowledge base and determining of a level deviation between the comparative sound pressure level and the sound pressure level of the acoustic signal,
providing of at least one psychoacoustic comparative variable by an appliance knowledge base and determining of at least one psychoacoustic deviation between the psychoacoustic comparative variable and at least one psychoacoustic variable of the acoustic signal,
defining the functional state of the household appliance as a function of at least the frequency deviation or the level deviation or at least one psychoacoustic deviation.

12. The method according to claim 1,
wherein
the functional state is characteristic of at least one of the following states:
fault-free or faulty operation of the household appliance,
the absence of at least one accessory of the household appliance,
a state of wear at least of at least one component or at least one accessory of the household appliance.

13. A monitoring system for monitoring a functional state of at least one household appliance, comprising at least one monitoring device, wherein the monitoring system is operated according to a method according to claim 1.

14. The monitoring system according to claim 13,
wherein
at least one household appliance is comprised, the monitoring device being integrated into the household appliance.

15. A computer program product comprising instructions that cause a monitoring system according to claim 13 to perform the stages of the method according to claim 1.

16. The method according to claim 2,
wherein at least the frequency spectrum or the level information or the psychoacoustic information are provided in the evaluation data set.

17. The method according to claim 5,
wherein the shading information is provided in the evaluation data set.

18. The method according to claim 7,
wherein the floor covering information is characteristic of a floor covering at the point of origin of the acoustic signal and the floor covering information is provided in the evaluation data set.

19. The method according to claim 11,
wherein at least the comparison frequency spectrum or the comparative sound pressure level or the psychoacoustic comparative variable are provided as a function of the evaluation data set and the appliance data set.

20. The method according to claim 11,
wherein the functional state of the household appliance is defined through a state knowledge base.
